(19) United States
(12) Patent Application Publication
(10) Pub. No.: US 2021/0405679 A1
(43) Pub. Date: Dec. 30, 2021

(54) AIRCRAFT SUN VISOR THUMB KNOB ATTACHMENT DEVICE

(71) Applicant: Ivan Ferrer, Longwood, FL (US)

(72) Inventor: Ivan Ferrer, Longwood, FL (US)

(21) Appl. No.: 16/912,375

(22) Filed: Jun. 25, 2020

(51) Int. Cl. G05G 1/10; B60J 3/02

(52) U.S. Cl. CPC G05G 1/10; B60J 3/0278

(57) ABSTRACT

An aircraft sun visor thumb knob attachment device includes a cylindrical-shaped main body having a top end, a bottom end, and a continuous side wall that defines an interior space. A plurality of protrusions are positioned along the inside facing surface of the side wall so as to extend within the interior space. The interior space includes a shape and a size that is complementary to the shape and the size of the grip portion of a known aircraft sun visor control knob. Likewise, each of the protrusions include a shape and size that are suitable for positioning within the indentations of the control knob. A grip assembly is positioned along the top end of the main body and includes a support member that is communicatively linked to a pair of elongated tabs. Each of the tabs include functionality for transitioning between a horizontal position and a vertical position.

### TECHNICAL FIELD

The present invention relates generally to aircraft sun visor systems, and more particularly to an attachment device for a sun visor thumb knob.

### BACKGROUND

The statements in this section merely provide background information related to the present disclosure and may not constitute prior art.

Most aircraft are equipped with some type of sun visor within the cockpit area to reduce UV rays, and to eliminate glare which can affect the pilot's ability to control the aircraft. Background FIG. 1 illustrates one embodiment of a monorail type visor system 1 that is most commonly utilized in corporate and commercial aircraft.

As shown, these systems typically include an elongated rail 2 that is mounted 3 along the upper portion of the cockpit, and has one or more sun visors 4 connected thereto. Each of these visors are secured onto the rail via a small thumb knob 5 that can be twisted by the pilot to allow the visor to slide along the length of the rail and/or pivot at different angles.

Unfortunately, the small diameter of these knobs poses problems for many pilots, as it is difficult to grasp. More specifically, many pilots note that it is difficult to impart a twisting force onto the knob with sufficient pressure to prevent unintended movement of the visor; whereas other pilots note that it is not uncommon for the knob to become stuck in place such that the pilot is unable to impart enough twisting force to loosen a frozen knob. In either circumstance, the pilot(s) are unable to effectively utilize the aircraft sun visor, and often resort to placing maps or other non-transparent articles onto the visor and/or windows to block the sun. Such actions are obviously dangerous, as the articles block the pilots view, and greatly diminish their situational awareness.

Accordingly, it would be beneficial to provide an attachment device for a sun visor thumb knob that can be utilized by pilots to overcome the problems described above.

### SUMMARY OF THE INVENTION

The present invention is directed to an aircraft sun visor thumb knob attachment device. One embodiment of the present invention can include a generally cylindrical-shaped main body having a top end, a bottom end, and a continuous side wall that extends downward to define an interior space.

A plurality of protrusions can be positioned along the inside facing surface of the sidewall so as to extend within the interior space. The interior space can be manufactured to include a shape and size that is complementary to the shape and size of the grip portion of an aircraft sun visor control knob. Likewise, each of the protrusions include a shape and size that are suitable for positioning within the indentations of the control knob so as to impart a twisting force thereto.

One embodiment of the present invention can also include a grip assembly that is positioned along the top end of the main body. The grip assembly can include a support member that is communicatively linked to a pair of elongated tabs. Each of the tabs include functionality for transitioning between a horizontal position that is optimized for receiving and imparting a twisting force onto a control knob, and a vertical position that is optimized for receiving a non-rotational force for installing and removing the device from the control knob.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a frontal perspective view of an aircraft sun visor system and control knob that is useful for understanding the inventive concepts disclosed herein.

FIG. 2 is a top perspective view of the attachment device, in accordance with one embodiment of the invention.

FIG. 3 is a bottom perspective view of the attachment device, in accordance with one embodiment of the invention.

FIG. 4 is a side view of the attachment device, in accordance with one embodiment of the invention.

FIG. 5 is a perspective view of the attachment device in operation, in accordance with one embodiment of the invention.

FIG. 6 is another perspective view of the attachment device in operation, in accordance with one embodiment of the invention.

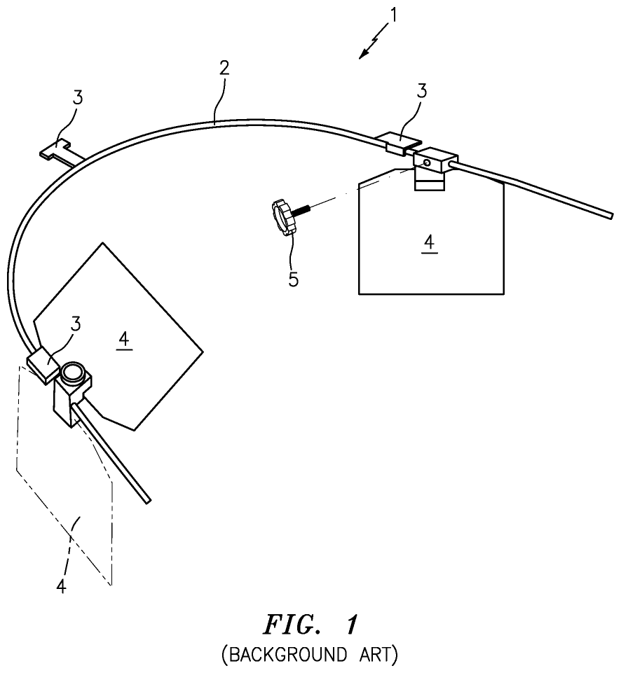

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As will be described below, the present invention is directed to an attachment device for use with an aircraft sun visor thumb knob. Although illustrated with regard to a specific type or manufacturer, it is to be distinctly understood that the present invention has broader applications. As such, other embodiments of the attachment device can be manufactured to include shapes, sizes and/or dimensions that are complementary to and/or suitable for use with many other types of thumb knobs without undue experimentation and without departing from the invention claimed.

As described herein, the term “removably secured,” and derivatives thereof shall be used to describe a situation wherein two or more objects are joined together in a non-permanent manner so as to allow the same objects to be repeatedly joined and separated.

As described throughout this document, the term “about” “approximately” and “Substantially” shall be used interchangeably to describe a feature, shape or measurement of an identified component within a tolerance such as, for example, manufacturing tolerances, measurement tolerances or the like.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

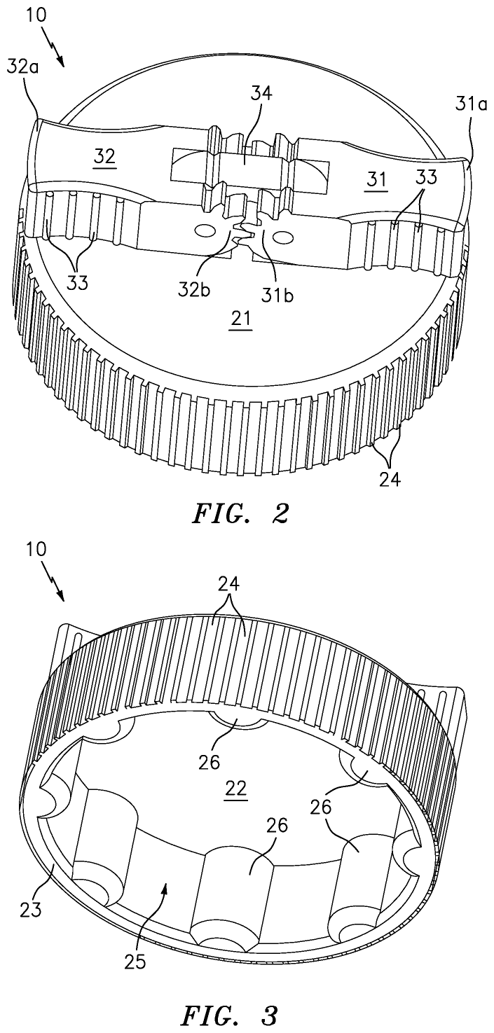

FIGS. 2-6 illustrate one embodiment of an attachment device 10 for an aircraft sun visor control knob that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

As shown, the device 10 can include a main body for receiving a control knob, and an adjustable grip assembly.

In one embodiment, the main body can include a generally cylindrical shaped member having a top surface 21, a bottom surface 22, and a continuous sidewall 23 extending from the top surface beyond the bottom surface 22. In the preferred embodiment, a plurality of ribbed edges 24 can be positioned along the entirety of the outside facing portion of the sidewall to assist in gripping.

As shown, the sidewall 23 and bottom surface 22 form a recess 25 along the underside of the device 10. A plurality of protrusions 26 are positioned along the inside facing portion of the sidewall 23 and extend within the recess 25. In the preferred embodiment, the recess 25 and protrusions 26 form a shape and size that is complementary to and/or fit directly onto the grip 5a of a control knob 5 such as the Standard Thumb Knob model RCBS-300-11M that is commercially available by Rosen Sunvisor Systems®, incorporated herein by reference.

The grip assembly can function to aid a user in operation of the device. In one embodiment, the grip assembly can a pair of elongated, generally rectangular-shaped tabs 31 and 32 each having a plurality of ribbed edges 33 along the side portions. Each of the tabs can include a flat distal end 31a and 32a, respectively, and cogged proximal ends 31b and 32b, respectively.

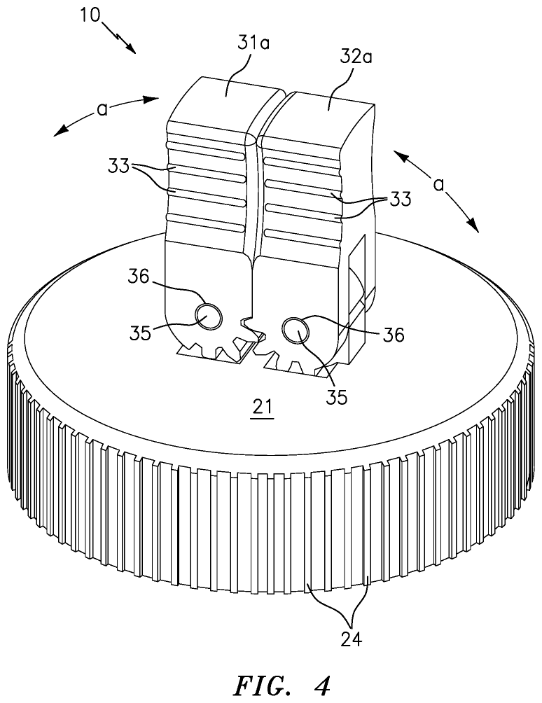

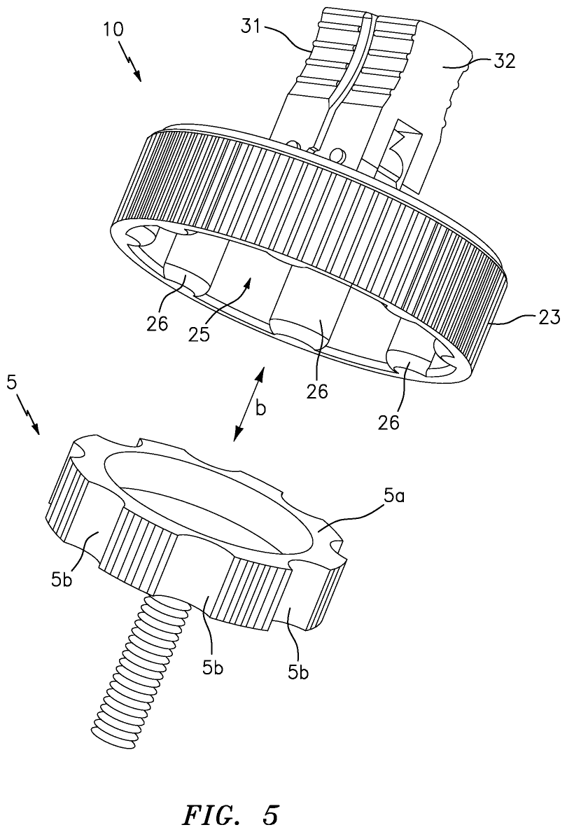

A support member 34 can extend upward from the center of the top surface 21. The support member including four dowels 35 for engaging openings 36 along the sides of the tabs. As shown by arrow a, when connected to the dowels, the interlocking cogged ends of the tabs permit uniform and simultaneous 90 degree movement of the tabs 31 and 32 about the dowels to transition between the horizontal orientation shown at FIG. 2 and the vertical orientation shown at FIG. 4.

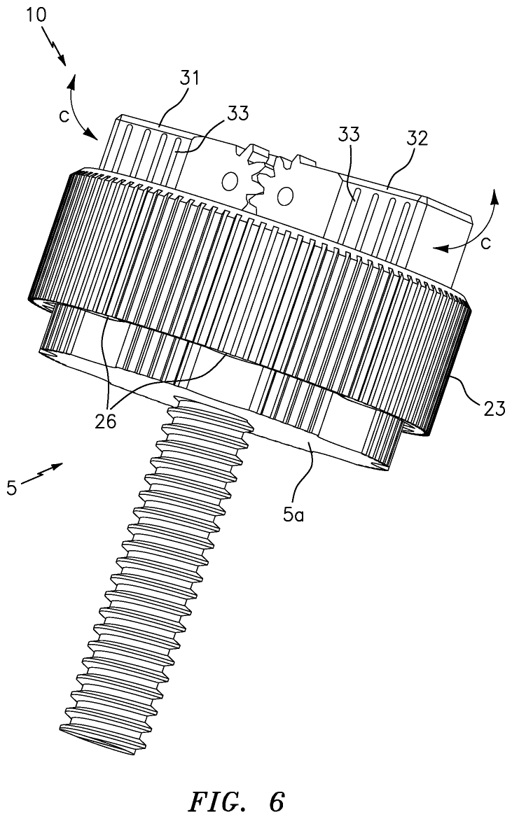

FIGS. 5 and 6 illustrate one embodiment of the device 10 in operation with a control knob 5. As shown by arrow b of FIG. 5, the bottom of the device 10 can be lowered over the control knob until the grip portion 5a is positioned within the recessed area 25. When so positioned, the protrusions 26 and indentations 5b are engaged. During installation and removal of the device, the tabs 31 and 32 will be in the vertical position. Such a feature advantageously provides the user with an elongated raised gripping surface having a major axis that is parallel to the direction of travel (e.g., shown by arrow b). As such, the vertical orientation of the tabs function as a raised handle that is optimized for non-rotational movement.

As shown at FIG. 6, once the knob 5 is positioned within the recessed area 25, the tabs can be folded to the shown horizontal position. When so positioned, each of the tab bodies 31 and 32 provide a continuous raised ledge that extends across the entire top end 21 of the main body. This continuous raised ledge along with the ribbed edges 33 provides a straight, non-circular gripping surface that is optimized for receiving a twisting force shown by arrow c. This twisting force imparted by the tabs is then transferred through the device and protrusions 26 onto the grip 5a of the knob 5, thus permitting controlled movement of the same.

Accordingly, the above described device provides users with the ability to selectively orient the tabs in a position that is optimized for rotational and non-rotational movement, so as to aid users in quickly and easily coupling the device to a control knob and utilizing the same.

As described herein, one or more elements of the attachment device 10 for an aircraft sun visor control knob can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An attachment device for a control knob, said attachment device comprising:
a cylindrical shaped main body having a top end, a bottom end, and a side wall;
an interior space that is positioned along a bottom surface of the main body, said interior space being defined by the bottom end and the side wall;
a plurality of protrusions that are positioned within the interior space along the side wall; and
a grip assembly that is positioned along the top end, said grip assembly being configured to impart a movement onto the main body.

2. The attachment device of claim 1, wherein the grip assembly includes a pair of elongated, rectangular-shaped tabs.

3. The attachment device of claim 2, wherein each of the pair of tabs further includes a first end, a second end, a middle portion, and a plurality of ribbed edges along the middle portion.

4. The attachment device of claim 3, wherein each of the pair of tabs are configured to be aligned serially and to extend across a central portion of the top end of the main body.

5. The attachment device of claim 3, wherein each of the pair of tabs are configured to be aligned parallel and to extend perpendicularly outward and away from a central portion of the top end of the main body.

6. The attachment device of claim 1, further comprising:
a plurality of ribbed edges that are positioned along an outside facing surface of the side wall.

7. The attachment device of claim 6, wherein the plurality of ribbed edges are positioned along an entirety of the outside facing surface of the side wall.

8. The attachment device of claim 1, wherein the interior space includes a shape and size that is complementary to a shape and a size of a grip of an aircraft sun visor control knob.
